(19) United States
(12) Patent Application Publication
(10) Pub. No.: US 2012/0322515 A1
(43) Pub. Date: Dec. 20, 2012

(54) Apparatus and Method to Indicate Power Saving Mode of a Network Element

(76) Inventors: Woonhee Hwang, Espoo (FI); Antti Anton Toskala, Espoo (FI); Michael Schopp, Ulm (DE)

(21) Appl. No.: 13/521,837

(22) PCT Filed: Jan. 12, 2010
(86) PCT No.: PCT/EP10/50256

§ 371 Date: Aug. 20, 2012

(51) Int. Cl. H04W 52/02

(52) U.S. Cl. 455/574

(57) ABSTRACT

A method of controlling the mode of a user equipment includes forwarding a message from the network element to the network indicating a request to move to a power saving mode/state; and moving the user equipment to a power saving state/mode. The method may including deciding at the network which state the network element is to move to; and indicating this and/or further data pertaining to said state/mode, to the network element. The mode may be an IDLE or Connected mode of LTE and includes an extended DRX cycle.

This disclosure relates a method of controlling a network element in a communication system in moving to a power saving or dormancy mode/state; and/or indicating this to a network. It has particular but not exclusive application to user equipment in cellular communication systems.

A communication system is a facility which facilitates the communication between two or more entities such as communication devices, network entities and other nodes. A communication system may be provided by one more interconnected networks. A communication device can be understood as a device provided with appropriate communication and control capabilities for enabling use thereof for communication with others parties. The communication may comprise, for example, communication of voice, electronic mail (email), text messages, data, multimedia and so on. A communication device typically enables a user of the device to receive and transmit communication via a communication system and can thus be used for accessing various service applications.

In cellular systems a network entity in the form of a base station provides a node for communication with user equipment (UE) such as mobile devices in one or more cells. A base station is often referred to as a ‘Node B’. There are many different techniques for processing signals for transmission between the base station and the user equipment. Typically the operation of a base station apparatus and other apparatus of an access system required for the communication is controlled by a particular control entity. The control entity is typically interconnected with other control entities of the particular communication network. In cellular communication systems such control entities are often referred to a radio network controllers.

A Universal Mobile Telecommunication System (UMTS) is a broadband, packet based system for the transmission of text, digitized voice, video and multi-media. It is a highly subscribed to standard for third generation and is generally based on Wideband Coded Division Multiple Access (W-CDMA). An example of the more recent developments in the standardization is the long-term evolution (LTE) of the Universal Mobile Telecommunications System (UMTS) radio-access technology that is being standardized by the 3rd Generation Partnership Project (3GPP). A further development of the LTE is referred to as LTE-Advanced.

In general, after a particular UE ceases to have user traffic exchange, usually the network will not know that this is the case, and will keep that particular UE in an active mode for a period until e.g. an implementation dependent timer has expired. However the UE often knows that there will not be further user traffic exchange. For example where a UE has a push-email type of application, after the push email is delivered; it is preferable then for the UE to move to an efficient power saving mode directly; in order to conserve battery power. In this application the UE is effectively an email client. For example, mail may be synchronised every hour and the UE automatically connects with network and downloads email from a mail server. The UE knows after this connection, it can go to IDLE directly. Push e-mail is used to describe e-mail systems that provide an always-on capability, in which new e-mail is actively transferred (pushed) as it arrives by the mail delivery agent (MDA) (commonly called mail server) to the mail user agent (MUA), also called the e-mail client. E-mail clients include smartphones and, less strictly, IMAP personal computer mail applications

Because of this, in UMTS systems, some UE applications are setup by some vendors, whereby a UE decides to move to an IDLE mode autonomously and notifies this to the network via a Signalling Connection Release Indication (SCRI). This is effectively a misuse of the SCRI message. Moreover, where several UEs in the field use this kind of procedure, it increases the network signalling overhead because, at some point the UE will need to be back in a connected mode, i.e. an RRC connection will need to be set up at some point in the future.

In a UMTS system, a UE sends a Signalling Connection Release Indication to the network and moves to IDLE in order to save battery power where Periodical connection to the network and no more data traffic and the (this) application behaviour is known by radio layer. In conventional UMTS systems, it has been proposed that that alternatively, the UE could rather move to Cell-PCH/URA-PCH state using a fast dormancy procedure, whereby the UE sends together with the SCRI message, a “cause value”. The “cause value” is an information element field in the SCRI message. The UE sets the value in this information element to say to the network that it should move to UTRA_PCH or Cell_PCH); i.e. informs the network that the device should be moved to URA_PCH or Cell_PCH state rather than the “idle” state. This is also distinguishable from the power off state. Such a solution however, is not applicable to LTE because in LTE system, UE has only two states, CONNECTED and IDLE. For LTE systems, a solution has been proposed to introduce RRC Connection Release Request message, arranged such that this message performs the same function as Signalling Connection Release Indication in UMTS system. However the same problem will occur in that this will cause excessive burden to the network as in UMTS system.

It is desirable to provide a method in which a UE can reduce its power consumption without substantially increasing signalling overhead.

In one embodiment of the invention is comprised a method of controlling the mode of a network element comprising: forwarding a message from the network element to the network indicating a request or indication of a move to a power saving mode/state; and moving the network element to a power saving state/mode.

In one embodiment it may include deciding at the network which state the network element is to move to; and indicating this and/or further data pertaining to said state/mode, to the network element. The network element may be a user equipment.

The power saving state/mode may be decided by the network element.

A message may be additionally received from said network acknowledging or allowing said network element to move to said power saving state/mode.

The said state/mode may be an extended Discontinuous Reception (DRX) cycle. The network may be a Long Term Evolved Network. The state/mode may be an IDLE mode of a UMTS and the extended DRX cycle is in CONNECTED mode of a UMTS.

Supplementary information may be sent, received and/or used by the network element and optionally included in determining the mode/state. This may comprise one or more of the following: information from the application layer of the network element; parameters relating to an extended DRX cycle; parameters relating to device power consumption; and/or parameters relating to periodicity of push email or other applications. It may include information relating to the period when the user element is to change further from said state/mode.
The state and/or data pertaining to said state/mode and/or said supplementary information indicated using a Radio Resource Control (RRC) or Media Access Control (MAC) message.

In an embodiment of the invention is provided also a computer readable medium comprising a computer program thereon, said computer program performing the methods.

In an embodiment of the invention is provided also a network element or processor therefor, having means to forward a message to a network indicating a move to or a request to move to a power saving state/mode, and means to subsequently move to a power saving state/mode.

It may include means to receive from the network information indicating a power saving state/mode to be moved to, and/or further data pertaining to said state/mode. The network element may be a user equipment.

The network element or processor therefor, may have means to decide said power saving mode/state, and means to receive an acknowledgment and/or confirmation to move to said state/mode from said network.

The network may be a Long Term Evolved Network.

The state may be an IDLE mode of Universal Mobile Telephone System (UMTS) or an extended DRX cycle. The extended DRX cycle may be in CONNECTED mode of a UMTS.

The network element or processor therefor, may include means to forward, receive and/or use supplementary information to the network, said supplementary information being one or more of the following: information from the application layer of the network element; information relating to the period when the user element is to change from said state/mode; parameters relating to an extended DRX cycle, parameters relating to device power consumption, and/or parameters relating to periodicity of push email or other applications.
The state/mode or said supplementary information is indicated by means to RRC or MAC message.

In an embodiment of the invention is also provided a network element or processor therefor comprising means to receive a message from a second network element indicating a move or a request to move to a power saving mode/state; and having either means to decide and indicate to the second network element which state it is to move to; or means to acknowledge/confirm said move to said second network element. The network element may be is a network controller or node B.
The second network element may be a user equipment. The network may be a Long Term Evolved Network.

The state may be an IDLE mode. The power saving mode/state may be an extended DRX cycle. The extended DRX cycle may be in CONNECTED mode of a LTE network.

The means to decide may include means to send, receive and/or use supplementary information from the second network element, said supplementary information being one or more of the following: information from the application layer of the second network element; information relating to the period when the user element is to change from said state/mode; parameters relating to an extended DRX cycle, parameters relating to device power consumption; and/or parameters relating to periodicity of push email or other applications.

The means to indicate or provide said state and/or said supplementary information may be via a MAC or RRC message.

### SUMMARY OF FIGURES

For a better understanding of the present invention and how the same may be carried into effect, reference will now be made by way of example only to the accompanying drawings in which:

FIG. 1 shows a schematic representation of a communication network;

FIG. 2 shows an example of a network element such a user equipment;

FIG. 3 illustrates a simple embodiment of the invention.

### DESCRIPTION OF BACKGROUND TO INVENTION

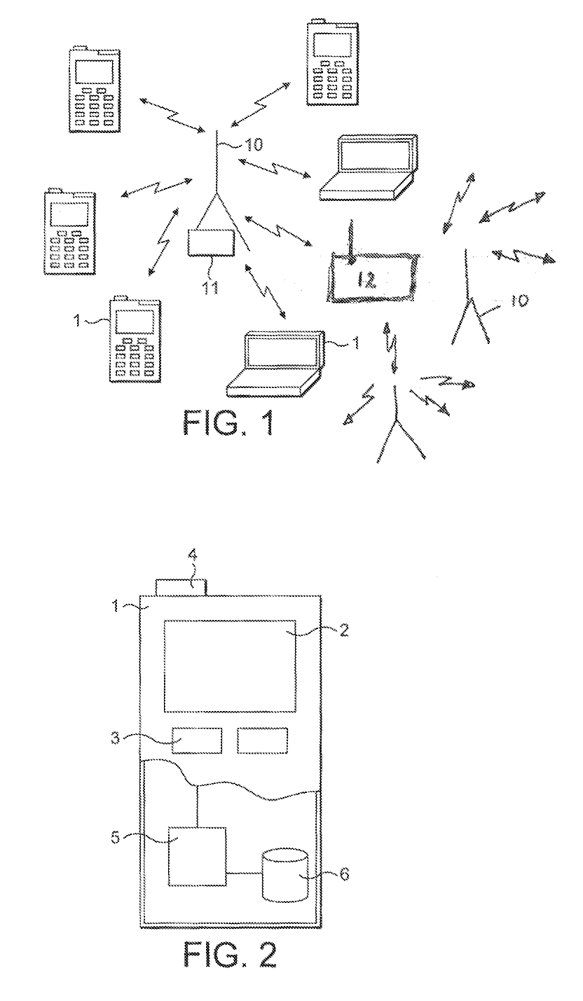

Before explaining in detail a few exemplifying embodiments, a brief explanation of wireless access is given with reference to FIG. 1 showing a communication system providing wireless communications to a plurality of communication devices 1. A communication device 1, for example a mobile user device, or equipment or a relay node, can be used for accessing various services and/or applications provided via the wireless communication system. A communication device can typically access wirelessly a communication system via at least one wireless transmitter and/or receiver node 10 of an access system. Non-limiting examples of access nodes are a base station of a cellular system, for example a 3G WCDMA Node B, an enhanced Node B (eNB) or relay node of 3GPP LTE (long term evolution), a base station of a wireless local area network (WLAN) and a satellite station of a satellite based communication system. The communication devices 1 may also communicate directly with each other.

The communications may be arranged in various manners based on an appropriate radio access technology or technologies. The access is provided via radio channels also known as access channels. Each communication device 1 may have one or more radio channels open at the same time. Each communication device may be connected to more than one base station 10 or similar entity. Also, a plurality of communicate devices may communicate with a base station or similar, and/or attempt to access the communication system via the same base station. A plurality of communication devices may also share a channel. For example, to start communications or to connect to a new access system, a plurality of communications devices may attempt to make the initial contact via a single channel, for example via a random access channel (RACH). The attempts to access may be made substantially at the same time.

The base station 10 of the access system can be connected to other parts of the communication system via appropriate connections. Base stations comprising part of a network are typically in communication with a network radio controller such as a Radio Network Controller 12. They may be connected to one or more appropriate gateway nodes. A base station is typically controlled by at least one appropriate controller apparatus (this is true for GSM and WCDMA. However in LTE and WiMAX there is no controller anymore, but control functionality is distributed to appropriate network elements such as general access nodes, base stations, nodeB's, eNBs, AP's) generally denoted by 11 in FIG. 1. The controller apparatus 11 can be provided for managing of the operation of the base station and/or communications via the base station. The controller apparatus is typically provided with memory capacity and at least one data processor. Various functional entities may be provided in the controller by means of the data processing capability thereof. The functional entities provided in the base station controller may provide functions relating to radio resource control, access control, packet data context control, relay control and so forth.

A communication device 1 can be used for various tasks such as making and receiving phone calls, for receiving and sending data from and to a data network and for experiencing, for example, multimedia or other content. For example, a communication device may access applications provided via a telephone network and/or a data network, such as applications that are provided based on the Internet Protocol (IP) or any other appropriate protocol. An appropriate mobile communication device may be provided by any device capable of at least sending and/or receiving wireless signals from the access system. Non-limiting examples include a mobile station (MS) such as a mobile phone or a smart phone, a portable computer provided with a wireless interface card or other wireless interface facility, personal data assistant (PDA) provided with wireless communication capabilities, or any combinations of these or the like.

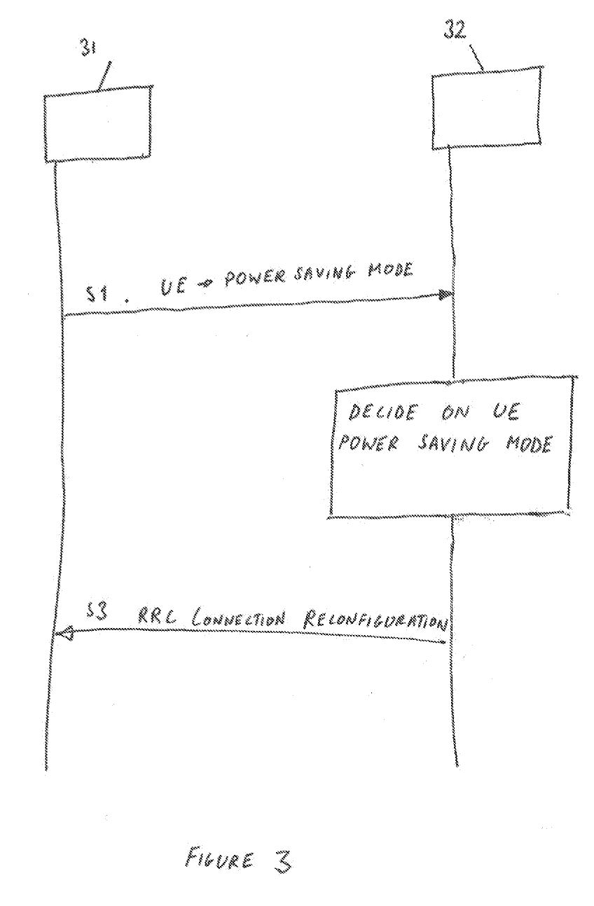

As shown in FIG. 2, a communication device 1 is typically provided with appropriate data processing apparatus, such as at least one data processor 5. At least one memory device 6 is also typically provided. The data processing and storage entities can be provided on an appropriate circuit board and/or in chipsets. Different functions and operations may be provided by different chips. Alternatively, at least partially integrated chips may be used. Antenna means 4, a display 2, and/or a keypad 3 may also be provided.

In a UMTS network, a Radio Resource Control (RRC) part of the protocol stack is responsible for assignment, configuration and release of radio resources between the UE and the network (e.g. UTRAN). Two basic modes that the UE can be in are defined as “idle mode” and UTRA RRC “connected mode”. UTRA stands for UMTS Terrestrial Radio Access. In idle mode, the UE or other mobile device is required to request a RRC connection whenever it wants to send any user data or in response to a page whenever the UTRAN or the Serving General Packet Radio Service (GPRS) Support Node (SGSN) pages it to receive data from an external data network.

In conventional UMTS networks, when in a UTRA RRC connected mode, the device can be in one of four states, these are: (i) CELL-DCH: A dedicated channel is allocated to the UE in uplink and downlink in this state to exchange data; (ii) CELL_FACH: no dedicated channel is allocated to the user equipment in this state. Instead, common channels are used to exchange a small amount of bursty data; (iii) CELL_PCH: the UE uses Discontinuous Reception (DRX) to monitor broadcast messages and pages via a Paging Indicator Channel (PICH), no uplink activity is possible; and, (iv) URA_PCH: the UE uses Discontinuous Reception (DRX) to monitor broadcast messages and pages via a Paging Indicator Channel (PICH)-again, no uplink activity is possible.

The transition from an idle mode to the connected mode and vice-versa is controlled by the UTRAN. When an idle mode UE requests an RRC connection, the network decides whether to move the UE to the CELL_DCH or CELL_FACH state. When the UE is in an RRC connected mode, again it is the network that decides when to release the RRC connection. The network may also move the UE from one RRC state to another prior to releasing the connection or in some cases instead of releasing the connection. The state transitions are typically triggered by data activity or inactivity between the UE and network. Since the network may not know when the UE has completed the data exchange for a given application, it typically keeps the RRC connection for some time in anticipation of more data to/from the UE. This is typically done to reduce the latency of call set-up and subsequent radio resource setup. After a particular UE ceases to have user traffic exchange, often the network will not know that this is the case, and the network will keep that particular UE in an active mode for a period until an implementation dependent timer has expired. After this the UE will slowly move to an “idle” mode. In the UMTS system, based on a timer located in the Radio Network Controller (RNC), the UE first moves to a CELL_FACH state from a CELL_DCH state and thereafter moves to CELL_PCH/URA_PCH or IDLE.

As mentioned, in LTE systems, a UE has only two states, CONNECTED and IDLE.

### DESCRIPTION OF INVENTION

In one embodiment of the invention, the UE may indicate to the network that it wants to move to a power saving mode. Once the network receives this indication, the network may decide the subsequent procedure. This may vary according to circumstances and/or any supplementary information received from the UE.

It is to be noted the term “network” is a general term for denoting any part of a communication system that is in communication with the network element (UE), and the functions of the network as far as embodiment of the invention are concerned, could be performed by any appropriate network element such as node B's, network controllers etc.

In one embodiment, the network may decide to configure an extended DRX cycle for the UE so that the UE can save the battery power efficiently. Discontinuous Reception (DRX) is a method used to negotiate phases in which data transfer occurs between the user equipment and network. During other times the device turns its receiver off and enters a low power state.

In LTE, an extended DRX cycle in CONNECTED mode is similar to the IDLE mode UE DRX in terms of the reduced signalling frequency. Thus UE can thereby achieve almost the same battery saving efficiency, whilst reducing overhead. In a preferred embodiment, to configure DRX more efficiently, UE can determine a DRX cycle to apply; i.e. determine DRX parameters. This may be based on information received from the application layer, if it is available in the UE.

In one embodiment, if the UE radio layer can get the information about a “keep-a-live” message, for example, if an application has to be connected periodically, like push email. This information can be forwarded inside UE. (Application layer to radio layer). This could be forwarded to the network so that network can take this information into account when it configures e.g. DRX configuration. A “keep alive” is a message sent by one device to another to check that the link between the two is operating. Another term sometimes used for this is the “heartbeat”, like that used in Push extensions for Internet Message Access Protocol (PUSH-IMAP)

FIG. 3 shows a schematic representation of one embodiment of the invention, and shows a user equipment 31 connected via a network 32. The network is designated generally and the skilled person would be aware it may compromise base stations and a network controller; e.g. a Radio Network Controller connected to the UE via base stations (Node Bs).

In step S1 the UE indicates via a message to the network (e.g. to a radio network controller) that it want to move to a power saving mode.

The network in step S2, (e.g. RNC) decides what action to take according to circumstances or set up and/or any supplementary information received from the UE. This decision may be to move the UE to an IDLE mode as in the case of UMTS systems. Alternatively the network (e.g. RNC) may configure the UE with a long DRX. This may be taking to account any supplementary information such as information provided by the UE.

In step S3, as a result the network will reply to the UE, sending a signal with appropriate information about the change of state the UE is allowed, along with any appropriate reconfiguration information.

In advantageous embodiment of the invention therefore, as the network has full control over UE state transition. The UE will not cause excessive burden to the network because transitions form IDLE to/from CONNECTED modes. Also in a preferred embodiment, as the UE can provide addition information about UE awaking period to the network, if for example this information can be provided by UE application layer. For example if the application knows how often it should be connected to network, this information can be forwarded from UE application layer to radio layer. If UE forwards this information to the network, the network can take into account this information when it sets DRX cycle. The network can then configure the UE DRX configuration more accurately so that UE will be awake at the correct time when an application is to be run. This allows a reduction in the delays relating to re-accessing the network and there is no need to separately to signal from the UE to modify the DRX cycle. On the other hand the long DRX cycle is then applied only to those devices which actually have such an application with constant interval between messaging instants (keep-alive messages with push email).

In one embodiment of the invention, after the network is sent a request to move to a power saving mode/state, the UE may autonomously move to that state e.g. in one example by applying a pre-configured DRX cycle. Any Physical Uplink Control Channel (PUCCH) or SRS resources may be released.

In a further embodiment the UE may await receiving a response from the network, e.g. an acknowledgement (ACK) message. The ACK message may contain data indicating the new state or mode for the UE and/or any configuration data therefor. Alternatively it may just be a simple “go-ahead” type acknowledgement.

As far as what triggers the request to be made by the UE, the skilled person would understand any appropriate trigger may be used to initiate the request to move to a power saving mode/state.

In a further embodiment the UE may provide to the network information either in the form of periodicity (how often the period connection with the other end occurs) and/or any appropriate timing reference if there is a fixed instant relative to the network timing when those signaling exchanges occur. This may be in the form of suggesting DTX parameters which the network would use and which would match the timing and periodicity of the application or combination of applications in use. There may be multiple applications with similar characteristics. For example, a combination of two or more of push email, instant messaging or widgets giving for example updates such as weather or news information updates.

The above described functions can be provided by means of appropriate software and data processing apparatus. Functions may be incorporated into any appropriate network element or management system and may be provided by means of one or more data processors. The data processor may be provided by means of, for example, at least one chip. Appropriate data processing may be provided in a processing unit provided in association with a communication device, for example a mobile station. The data processing may be distributed across several data processing modules. The above described functions may be provided by separate processors or by an integrated processor. An appropriately adapted computer program code product or products may be used for implementing the embodiments, when loaded on an appropriate data processing apparatus. The program code product for providing the operation may be stored on and provided by means of an appropriate carrier medium. An appropriate computer program can be embodied on a computer readable record medium. A possibility is to download the program code product to a communication device via a data network.

It is also noted that although certain embodiments were described above by way of example with reference to certain exemplifying architectures for wireless networks, technologies and standards, embodiments may be applied to any other suitable forms of communication systems than those illustrated and described herein.

It is also noted herein that while the above describes exemplifying embodiments of the invention, there are several variations and modifications which may be made to the disclosed solution without departing from the scope of the present invention.

1. A method of controlling the mode of a network element comprising:
forwarding a message from the network element to the network indicating a request or indication of a move to a power saving mode/state; and moving the network element to a power saving state/mode.

2. A method as claimed in claim 1 including deciding at the network which state the network element is to move to; and indicating this and/or further data pertaining to said state/mode, to the network element.

3. A method as claimed in claim 1 wherein said network element is a user equipment.

4. A method as claimed in claim 1 wherein said power saving state/mode is decided by the network element.

5. A method as claimed in claim 4 including receiving message from said network acknowledging or allowing said network element to move to said power saving state/mode.

6. A method as claimed in claim 1 wherein said state/mode is an extended Discontinuous Reception (DRX) cycle.

7. A method as claimed in claim 1 wherein said network is a Long Term Evolved Network.

8. A method as claimed in claim 7 wherein state/mode is an IDLE mode of a Universal Mobile Telephone System (UMTS) system.

9. A method as claimed in claim 6 wherein the extended DRX cycle is in CONNECTED mode of a UMTS.

10. A method as claimed in claim 1 wherein supplementary information is sent, received and/or used by the network element and optionally included in determining the mode/state.

11. A method as claimed in claim 10 wherein said supplementary information comprises one or more of the following: in-formation from the application layer of the network element; parameters relating to an extended DRX cycle; parameters relating to device power consumption; and/or parameters relating to periodicity of push email or other applications.

12. A method as claimed in claim 10 wherein said supplementary information includes information relating to the period when the user element is to change further from said state/mode.

13. A method as claimed in claim 1 wherein said state and/or data pertaining to said state/mode and/or said supplementary information is indicated using a Radio Resource Control (RRC) or Media Access Control (MAC) message.

14. A computer readable medium comprising a computer program thereon, said computer program performing the method of claim 1.

15. (canceled)

16. (canceled)

17. (canceled)

18. (canceled)

19. (canceled)

20. (canceled)

21. (canceled)

22. (canceled)

23. (canceled)

24. (canceled)

25. A network element or processor therefor comprising means to receive a message from a second network element indicating a move or a request to move to a power saving mode/state; and having either means to decide and indicate to the second network element which state it is to move to; or means to ac-knowledge/confirm said move said second network element.

26. A network element or processor therefor, as claimed in claim 25, which is a network controller or node B.

27. A network element or processor therefor, as claimed in claim 25 wherein said second network element is a user equipment.

28. A network element or processor therefor as claimed in claim 25 wherein said network is a Long Term Evolved Network.

29. A network element or processor therefor as claimed in claim 25 wherein state is an IDLE mode.

30. A network element or processor therefor as claimed in claim 25 wherein said power saving mode/state is an extended DRX cycle.

31. A network element or processor therefor, as claimed in claim 30 wherein said extended DRX cycle is in CONNECTED mode of a UMTS network.

32. A network element or processor therefor, as claimed in claim 25, wherein said means to decide includes means to send, receive and/or use supplementary information from the second network element, said supplementary information being one or more of the following: information from the application layer of the second network element; information relating to the period when the user element is to change from said state/mode; parameters relating to an extended DRX cycle, parameters relating to device power consumption; and/or parameters relating to periodicity of push email or other applications.

33. A network element or processor therefor as claimed in claim 25 having means to indicate or provide said state and/or said supplementary information via a MAC or RRC message.
